(19) United States
(12) Patent Application Publication
(10) Pub. No.: US 2015/0232366 A1
(43) Pub. Date: Aug. 20, 2015

(54) TUNABLE MOLD SYSTEM FOR GLASS PRESS BENDING EQUIPMENT

(71) Applicant: CORNING INCORPORATED, Corning, NY (US)

(72) Inventors: Michele Fredholm, Vulaines sur Seine (FR); Laurent Joubaud, Paris (FR); Stephane Poissy, Brunoy (FR)

(21) Appl. No.: 14/621,608

(22) Filed: Feb. 13, 2015

Related U.S. Application Data
(60) Provisional application No. 61/941,237, filed on Feb. 18, 2014.

(51) Int. Cl. C03B 23/03

(52) U.S. Cl. CPC C03B 23/03

(57) ABSTRACT

A mechanism for bending glass comprising a seating device and a mold configured to bend a substrate to a desired shape, the substrate adaptable to be provided on the seating device. A position of the mold in relation to the seating device can be controlled by a programmable counterweight system.

### CROSS-REFERENCE TO RELATED APPLICATIONS

This application claims the benefit of priority under 35 U.S.C. §119 of U.S. Provisional Application Ser. No. 61/941,237, filed on Feb. 18, 2014, the content of which is relied upon and incorporated herein by reference in its entirety.

### BACKGROUND

Lehrs for annealing and tempering of glass structures are generally known. For example, U.S. Pat. No. 4,481,025 describes a conventional lehr for heat treating glass structures whereby the lehr is comprised of a series of modules which define an elongated insulated tunnel. A belt conveyor extends through the tunnel for moving glass structures from one end to the other. Duct work connections between the tunnel and ambient air, along with heaters and blowers can establish heating, tempering, and cooling zones within the lehr in the direction of conveyor movement.

Such conventional lehrs, however, cannot provide controlled heating and cooling of thin glass structures and glass laminate structures to prevent wrinkling thereof. Further, such conventional lehrs do not provide in situ bending or forming of thin glass structures.

### SUMMARY

Some embodiments of the present disclosure include a mechanism for bending glass is provided comprising a seating device and a mold configured to bend a substrate to a desired shape, the substrate adaptable to be provided on the seating device, sometimes referred to as a ring, wherein a position of the mold in relation to the seating device is controlled by a programmable counterweight system.

In other embodiments, a mechanism for bending thin glass is provided comprising a seating device and a mold configured to bend a substrate to a desired shape, the substrate adaptable to be provided on the seating device, wherein a position of the mold in relation to the seating device is controlled by a programmable counterweight system utilizing a pressure profile, force profile, temperature profile or combinations thereof to apply or reduce force of the mold on the seating device.

In further embodiments, a mechanism for bending thin glass is provided comprising a seating device, and a mold configured to bend a substrate to a desired shape, the substrate provided on the seating device, wherein a position of the mold in relation to the seating device is controlled by a programmable counterweight system utilizing pressure, force, temperature profiles or combinations thereof to apply or reduce force of the mold on the seating device. The programmable counterweight system comprises a plurality of guide devices fixedly attached to the mold on a proximate end of each rod and movably connected to screws at a distal portion of each device, an adjustable counterweight connected to each of the plurality of guide devices, and one or more motors configured to attach to the screws, wherein rotational movement of the one or more motors is translated to linear movement of one or more of the plurality of guide devices to effect linear travel of the mold and to effect lateral or transverse tilt to the mold.

Additional features and advantages of the claimed subject matter will be set forth in the detailed description which follows, and in part will be readily apparent to those skilled in the art from that description or recognized by practicing the claimed subject matter as described herein, including the detailed description which follows, the claims, as well as the appended drawings.

It is to be understood that both the foregoing general description and the following detailed description present embodiments of the present disclosure, and are intended to provide an overview or framework for understanding the nature and character of the claimed subject matter. The accompanying drawings are included to provide a further understanding of the present disclosure, and are incorporated into and constitute a part of this specification. The drawings illustrate various embodiments and together with the description serve to explain the principles and operations of the claimed subject matter.

### BRIEF DESCRIPTION OF THE DRAWINGS

For the purposes of illustration, there are forms shown in the drawings that are presently preferred, it being understood, however, that the embodiments disclosed and discussed herein are not limited to the precise arrangements and instrumentalities shown.

FIG. 1 is a series of deformation plots of bent glass structures showing modeled stresses in MPa.

FIG. 2 is another deformation plot of a bent glass structure showing modeled stresses in MPa.

FIG. 3 is a simplified illustration of an exemplary lehr according to some embodiments of the present disclosure.

FIGS. 4A and 4B are illustrations of exemplary heating elements according to some embodiments of the present disclosure.

FIG. 5 is a simplified diagram of a press-assist module according to some embodiments of the present disclosure.

FIG. 6 is a graphical side depiction of one embodiment of an exemplary pressing system.

FIG. 7 is a perspective view of the mold and overhead mechanism of FIG. 6.

FIGS. 8A-8D are simplified depictions of the overhead mechanism of FIG. 6.

### DETAILED DESCRIPTION

In the following description, like reference characters designate like or corresponding parts throughout the several views shown in the figures. It is also understood that, unless otherwise specified, terms such as “top,” “bottom,” “outward,” “inward,” and the like are words of convenience and are not to be construed as limiting terms. In addition, whenever a group is described as comprising at least one of a group of elements and combinations thereof, it is understood that the group may comprise, consist essentially of, or consist of any number of those elements recited, either individually or in combination with each other.

Similarly, whenever a group is described as consisting of at least one of a group of elements or combinations thereof, it is understood that the group may consist of any number of those elements recited, either individually or in combination with each other. Unless otherwise specified, a range of values, when recited, includes both the upper and lower limits of the range. As used herein, the indefinite articles “a,” and “an,” and the corresponding definite article “the” mean “at least one” or “one or more,” unless otherwise specified.

The following description of the present disclosure is provided as an enabling teaching thereof and its best, currently-known embodiment. Those skilled in the art will recognize that many changes can be made to the embodiment described herein while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations of the present disclosure are possible and may even be desirable in certain circumstances and are part of the present disclosure. Thus, the following description is provided as illustrative of the principles of the present disclosure and not in limitation thereof.

Those skilled in the art will appreciate that many modifications to the exemplary embodiments described herein are possible without departing from the spirit and scope of the present disclosure. Thus, the description is not intended and should not be construed to be limited to the examples given but should be granted the full breadth of protection afforded by the appended claims and equivalents thereto. In addition, it is possible to use some of the features of the present disclosure without the corresponding use of other features. Accordingly, the following description of exemplary or illustrative embodiments is provided for the purpose of illustrating the principles of the present disclosure and not in limitation thereof and may include modification thereto and permutations thereof.

Some embodiments of the present disclosure include a press bending process and system for the generation of complex shapes in a glass substrate or in glass laminate structures. In contrast to conventional standard sagging processes, exemplary systems and machines described herein can include a ring were the substrate can be seated and heated whereby a suspended mold can be utilized to press the glass into a desired shape. Conventionally, pressing force was defined by a mold weight which was dropped on the glass sheet and an adjacent ring; however, when too much force was applied, the substrate was press marked resulting in low quality bent glass products. Exemplary embodiments can thus include a counterbalance system to adjust the pressing force and spread the compensated force more uniformly and to limit mold press marks on the glass parts. Such systems can also be employed for bending soda lime glass down to thicknesses of 2.1 mm. Bending thin glass having thicknesses below 2.1 mm, or thicknesses below 1.6 mm or thicknesses between 0.3 mm and 1.5 mm, however, is difficult as thin glass does not bend in the same manner as thicker (1.6 mm and above) glass. Embodiments of the present disclosure can be utilized to bend both thick glasses (thicknesses greater than about 1.6 mm) and thin glasses.

Glass covers for devices with electronic displays or touch controls are increasingly being formed of thin glass that has been chemically strengthened using an ion exchange process, such as Gorilla® Glass from Corning Incorporated. Automotive applications, e.g., windshields, side windows or lites, rear windows, sunroofs, etc., are also being formed of thin glass to meet emissions requirements. Such chemically strengthened glass can provide a thin, lightweight glass structure with an enhanced fracture and scratch resistance, as well as an enhanced optical performance. Ion exchangeable glasses typically have a relatively higher CTE than non-ion exchangeable glasses. Ion exchangeable glasses may, for example, have a high CTE in the order of 70×10⁻⁷ C⁻¹ to 90×10⁻⁷ C⁻¹. Exemplary thin glass sheets according to embodiments of the present disclosure can have a thickness of up to about 2.1 mm, up to about 1.5 mm or 1.6 mm, up to about 1 mm, up to about 0.7 mm, or in a range of from about 0.5 mm to about 1.5 mm, or from about 0.5 mm to about 0.7, or from 0.3 mm to about 0.7 mm.

Assembly tolerances in the order of +/−0.5 mm or less are often required to provide the desired quality look, feel, fit and finish for a specific application. Such tolerances are difficult to achieve when performing high temperature, localized, high precision bending of relatively high CTE or relatively large glass sheets or structures, e.g., a laminate structure having a dimension of over 1 m², of ion exchangeable glass. When heating a relatively large glass sheet or a relatively high CTE glass sheet to a temperature that softens the glass so that it can be bent or formed to the desired shape, the sheet of glass can expand by as much as 10 mm in one or more directions. This expansion of the glass creates challenges in maintaining high precision tolerances when heating and bending the glass sheet. After bending the ion exchangeable glass to the correct shape, the glass can be ion exchanged to provide the desired chemical strengthening or tempering of the glass sheet.

The present disclosure provides a solution for precision shaping of large glass sheets, in particular relatively large sheets of relatively high CTE glass, using a localized high temperature bending processes, and more particularly thin, relatively high CTE sheets. The term “thin” as used herein means a thickness of up to about 2.1 mm, up to about 1.5 mm or 1.6 mm, up to about 1.0 mm, up to about 0.7 mm, or in a range of from about 0.5 mm to about 1.0 mm, or from about 0.5 mm to about 0.7 mm or from about 0.3 mm to about 0.7 mm. The terms “sheet”, “structure”, “glass structures”, “laminate structures” may be used interchangeably in the present disclosure and such use should not limit the scope of the claims appended herewith.

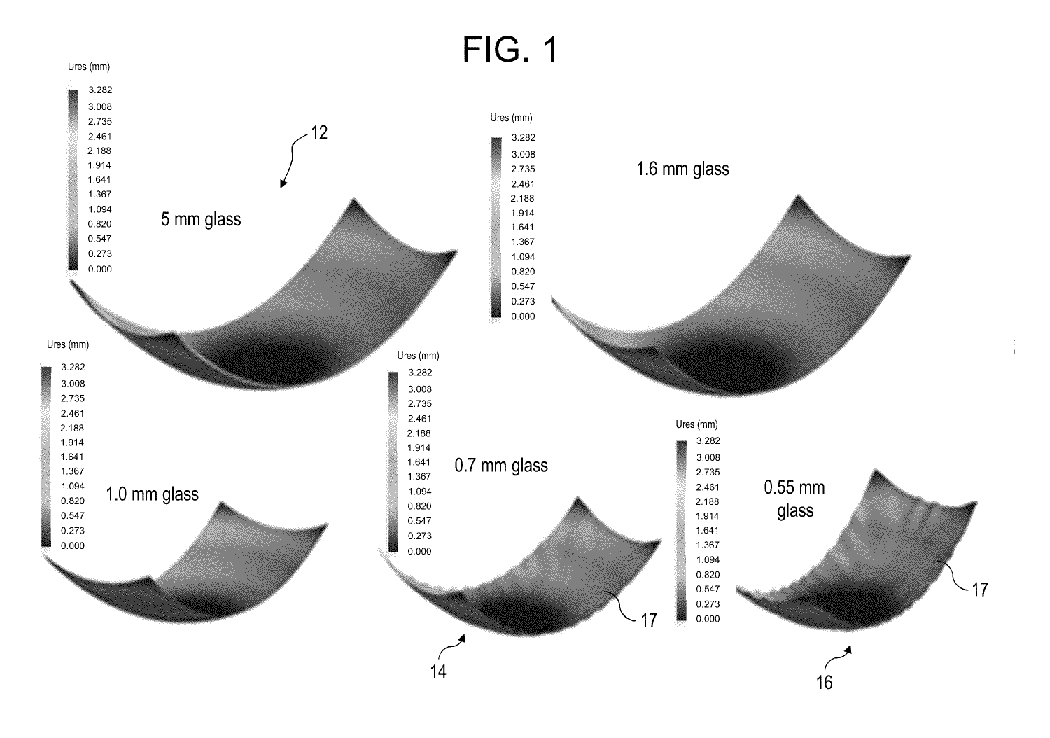

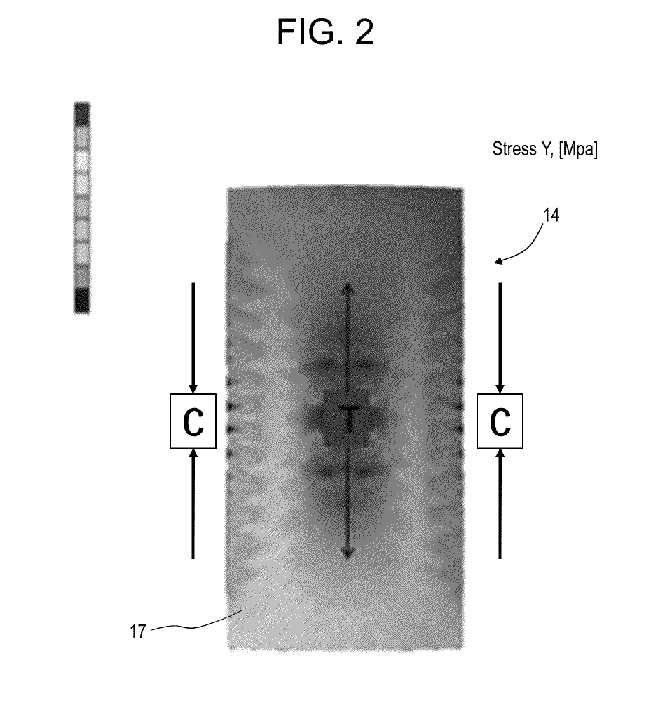

Applicant has discovered that bending thin glass is significantly different than bending conventional thicknesses of glass. FIG. 1 is a series of deformation plots of bent glass structures showing modeled stresses in MPa. As shown in FIG. 1, the interior portions of the illustrated bent glass structures exhibit tension whereas the exterior portions thereof exhibit compressive stress. Thicker glass structures, such a 5 mm thick glass structure or laminate 12, do not exhibit unacceptable wrinkling; however, such is not the case with thin glass structures such as 0.7 mm thick glass structures or laminates 14 and 0.55 mm thick glass structures or laminates 16 which exhibit this unacceptable wrinkling. Applicant has discovered that this wrinkling 17 is due, in part, to the bending process of these glass structures which creates a strong membrane tension in the glass center with large compressive hoop stresses near the edges. The balancing of these tension and compressive stresses result in edge wrinkling in thin glass structures and laminates as exhibited in FIG. 2. It has also been discovered that the degree of curvature of the glass or laminate structure (i.e., the complexity of the bent shape) adds to the degree of wrinkling thereof.

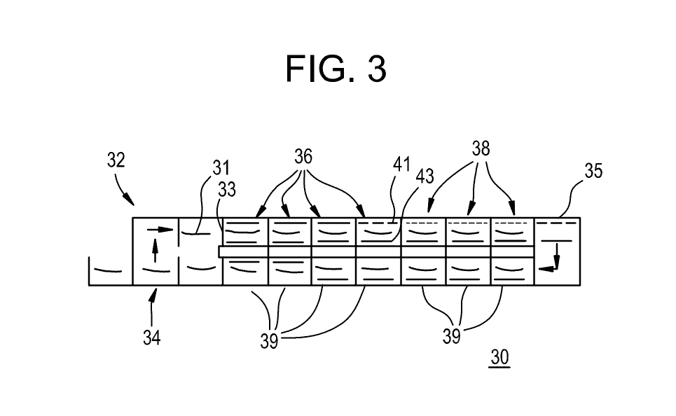

FIG. 3 is a simplified illustration of an exemplary lehr according to some embodiments of the present disclosure. With reference to FIG. 3, an exemplary lehr 30 can include a plurality of “wagons” or modules 32. In one embodiment, the lehr 30 can include eighteen modules 32. Of course, exemplary lehrs 30 can include more or less than eighteen modules 32 depending upon the size and/or thickness of a respective part or structure to be bent, the number of molds for the structure(s), and the number of glass parts or structures per mold. Adjacent modules can be separated from each other by blast or furnace doors 33 or other suitable mechanisms. The lehr 30 can include a suitable feeding mechanism to feed a sheet of glass or a laminate structure 31 into a loading lift module 34 whereby the structure 31 is conveyed into successive modules by a conveyance mechanism. Exemplary conveyance mechanisms include, but are not limited to, transfer rolls, conveyance carriages, and other suitable carts or carriages in the industry. In some embodiments, a conveyance mechanism can include suitable substrate or sheet registration mechanisms such as, but not limited to, the registration mechanisms described in pending U.S. application Ser. No. 13/303,685, the entirety of which is incorporated herein by reference. In one embodiment, the glass or laminate structure 31 can be conveyed from the loading lift module 34 into one or more preheating or heating modules 36. In the embodiment depicted in FIG. 3, a series of four or more heating modules 36 can be provided to advance or increase the temperature of the laminate structure 31 to a desired temperature or to meet a desired temperature profile. Of course, any number of heating modules 36 are envisioned in embodiments of the present disclosure and such a depiction should not so limit the scope of the claims appended herewith.

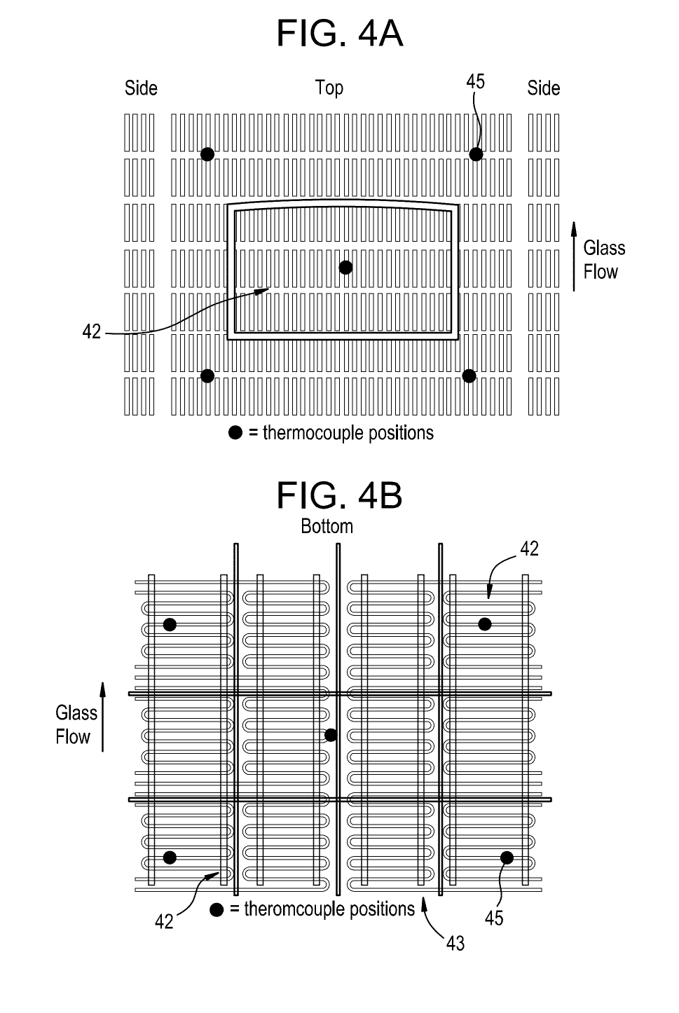

FIGS. 4A and 4B are illustrations of exemplary heating elements according to some embodiments of the present disclosure. With reference to FIGS. 4A and 4B and with continued reference to FIG. 3, any one or several of the modules 32 in an exemplary lehr 30 can include a top set of heating elements 31 and/or a bottom set of heating elements 43 in a respective module 32. These heating elements 41, 43 can be arranged to form heating and/or cooling zones 42 any of which can be independently controllable. Of course, the number of zones depicted in FIGS. 4A and 4B is exemplary only and should not limit the scope of the claims appended herewith as additional heating/cooling zones can be provided in any of the modules 32. Exemplary heating elements can be, but are not limited to, electrically conductive ceramic materials (e.g., silicon carbide, disilicide molybdenum, titanium diboride, etc.) generally shaped as straight or curved tubes which can be employed to dissipate power via heat radiation into a furnace environment, e.g., a module 32 of an exemplary lehr. In one embodiment, exemplary heating elements can be those described in U.S. application Ser. No. 13/302,586, the entirety of which is incorporated herein by reference.

While not shown in FIG. 3, each set of heating elements 41, 43 can include a plurality of thermocouples and/or pyrometers 45 provided at predetermined positions in the module to allow proper monitoring and control of each element or set of elements or zones. The thermocouples/pyrometers 45 are adaptable to send signals to the control system to regulate the exact temperature control within a respective module 32 through the starting and stopping of any individual or set(s) of heating elements 41, 43 in a respective module 32 thereby controlling the heating and cooling of a glass sheet or laminate structure in a respective module 32. In another embodiment of the present disclosure, shielding material (not shown) such as, but not limited to, aluminosilicate refractory fibers or another suitable insulative material, can be utilized to assist in the heating and cooling of a respective glass sheet or laminate structure within a module(s) 32. For example, it was discovered that many complex bent, thin glass part shapes for automotive or other applications required a level of differential heating that cannot be fully achieved with furnace heating control alone. Thus, in such cases, a combination of differential heating element control with appropriate shielding materials/panels (dynamic or static) can be employed. Exemplary static shielding can be employed directly on a respective glass sheet or laminate structure or can be a function of the carrying mold or conveyance mechanism. Exemplary dynamic shielding can be employed and controlled utilizing an exemplary movable shielding mechanism within a respective module 32 that is controlled using an exemplary control system. After an exemplary laminate structure 31 has been elevated to a desired temperature, the laminate structure 31 can be conveyed from the series of heating modules 36 to one or more bending modules 38 whereby the laminate structure 31 can be bent to a desired shape. Exemplary bending or pressing modules 38 can also include top and bottom heating elements 41, 43 to maintain and/or control the temperature of the glass or laminate structure 31 contained within the respective bending module 38 as will be described later.

Upon obtaining a desired shape, the laminate structure 31 can then be provided to an additional lift module 35 whereby the laminate structure 31 is conveyed to one or more successive cooling modules 39. The additional lift module 35 can include top and bottom heating elements 41, 43 and respective thermocouples/pyrometers 45 to maintain and/or control the temperature of the bent glass or laminate structure 31 contained therein. Exemplary cooling modules 39 can also include top and/or bottom heating elements 41, 43 and respective thermocouples/pyrometers 45 to provide a controlled cooling of the temperature of the bent glass or laminate structure 31 contained therein. It should be noted that the exact temperature control within any of the lift module 35 and cooling modules 39 can, like the heating modules 36, bending modules 38, etc., be regulated through the starting and stopping of any individual or set(s) of heating elements 41, 43 in a respective module to thereby control the heating and cooling of a bent glass sheet or laminate structure in a respective module. In another embodiment of the present disclosure, shielding (not shown) can be utilized to assist in the heating and cooling of a respective glass sheet or laminate structure within the module(s). Upon being cooled to a predetermined temperature, the bent glass or laminate structure 31 can then exit the series of cooling modules 39 into the loading module 34. While the embodiment depicted in FIG. 3 is illustrated as a stacked lehr embodiment (e.g., heating features and cooling features stacked upon each other along with lift modules), the claims appended herewith should not be so limited as an exemplary lehr can be substantially linear in form, that is, an exemplary glass or laminate structure to be bent is not conveyed vertically by a lift module but is only conveyed horizontally along a series of heating, bending and cooling modules. Additional lehr and heating embodiments are described in U.S. Application No. 61/846,692 filed Jul. 16, 2013 and entitled, “System and Method for Bending Thin Glass,” the entirety of which is incorporated herein by reference.

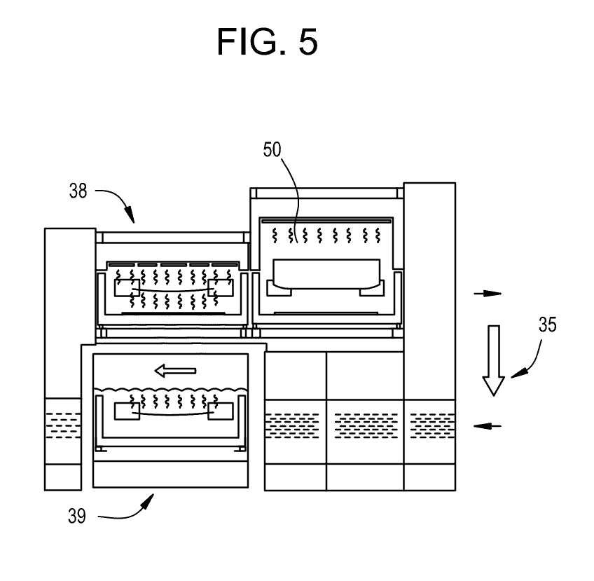

With continued reference to FIG. 3, to locally bend or form a thin glass sheet or laminate structure into a desired shape, the glass sheet or structure can be supported on a frame or mold in an exemplary bending or pressing module 38. The glass sheet or laminate structure can then be allowed to sag, e.g., deform to the shape of the mold under its own weight while the structure is held in an appropriate temperature range. In another embodiment, a force or press-assist mechanism 50 as illustrated in FIG. 5 can be applied to the glass or laminate structure to aid in the deformation thereof and/or to assist deformation of the structure to difficult shapes and bend tolerances, e.g., automotive windshields, sunroofs and other applications. Further, embodiments of the present disclosure can further provide a full surface mold press for varying depth shapes (e.g., 10 mm to 25 mm shapes) to develop deep complex curvatures that cannot conventionally be generated with localized temperature gradients. An exemplary press-assist module or mechanism 50 can also include a continuously varying ram speed (e.g., approaching 0.01 mm/sec or more) to assist in shaping such complex curvatures. Such an exemplary press-assist mechanism 50 or module can be provided between one bending module 38 and an exemplary lift module, and the capacity of an exemplary lehr 30 can be a function of the size of a respective part or structure, number of molds and/or modules, and the number of glass panes or structures per mold.

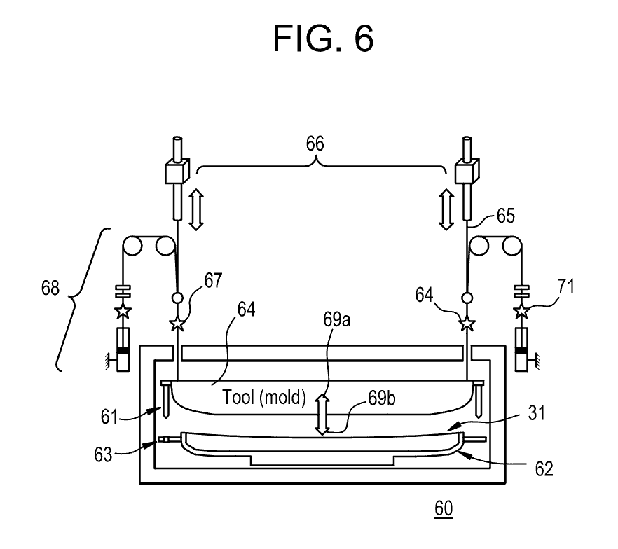

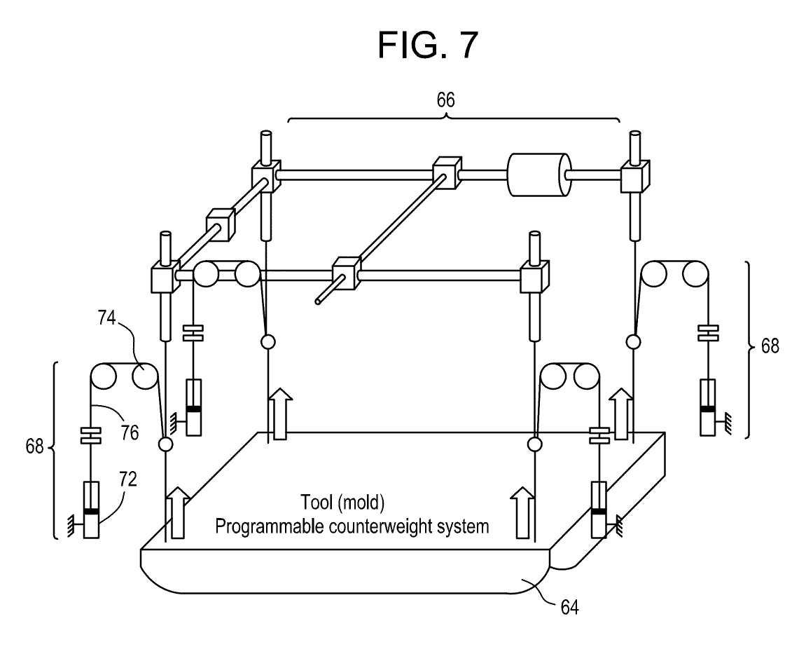

With continued reference to FIGS. 3 and 5, in some embodiments exemplary bending modules 38 can include a tunable mold system integrated therein. In other embodiments, a tunable mold system can be integrated into a press assist module provided between bending modules 38 and the lift module 35 in a press-assist module 50. FIG. 6 is a graphical side depiction of one embodiment of an exemplary pressing system. FIG. 7 is a perspective view of the mold and overhead mechanism of FIG. 6. With reference to FIGS. 6 and 7, an exemplary pressing module or system 60 is illustrated having a glass sheet or laminate structure 31 seated onto a ring or ring mechanism 62. The glass sheet or laminate structure 31 can be maintained at a predetermined temperature, e.g., 600° C., 650° C., 700° C., 750° C., etc. or can be heated up to such an exemplary temperature in the pressing module 60 using a temperature profile as described in U.S. Application No. 61/846,692 filed Jul. 16, 2013 the entirety of which is incorporated herein by reference. One or more molds 64 can be pressed against the glass sheet or laminate structure 31 to form a desired glass or laminate shape. In some embodiments, the mold 64 can be aligned with the ring or ring mechanism 62 utilizing one or more alignment pins 61 fixedly attached to the mold 64. These alignment pins 61 can mate with corresponding alignment interfaces 63 on the ring mechanism 62. In some embodiments, a plurality of alignment pins 61 can be provided where one or more alignment pins 61 set a location for the mold 64 with respect to the ring mechanism 62 and another alignment pin(s) 61 define an orientation of the mold 64 with respect to the ring mechanism 62. While not shown, rolls can also be utilized to minimize friction between moving parts in the pressing module 60. Control and movement of the mold 64 can be provided utilizing an exemplary overhead mechanism 66. In some embodiments, the mold 64 can be suspended with cables, lifting screws, guide rods, chains 65 or another suitable mechanism. An exemplary counterweight system 68 may also allow an operator to set a fully adjustable counterweight force on each corner or portion of a respective mold 64. In some embodiments, this adjustable counterweight force can be programmable along the entire stroke of the mold or portions thereof from a first suspended position 69a through and to a second position 69b interfacing with or contacting the glass sheet or laminate structure 31. It should be noted that while one mold and ring have been depicted and described, the claims appended herewith should not be so limited as embodiments can include a single mold and multiple rings, multiple molds and multiple rings, etc.

Exemplary force measurement systems 67 including, but not limited to, mechanical, digital, torque force gauges, sensors and the like can be employed in the pressing module 60 to provide force values for computational, programmable and control purposes for the counterweight force. Additionally, conventional stroke measurement systems 71 can be utilized to measure, compute and control stroke of the mold from the first position 69a through and to the second position 69b. An exemplary counterweight system 68 can include a cable, chain or other suitable mechanism 76 which transfers force from a counterweight, hydraulic or pneumatic piston, or other counterweight force 72 via a pulley system 74 to the mold 64. An exemplary amount of force can be a fixed value proportional to the mold weight and/or can also be adjusted manually, automatically or programmed by use of, in one embodiment, a low friction cylinder 72 having pressure settable by a by a pressure control valve (e.g., pneumatic, hydraulic, or the like). Such an exemplary arrangement can thus enable low friction, high precision counterweight force management to an exemplary mold 64 in a pressing module. As illustrated in FIG. 7, a plurality of counterweight systems 68 can be employed for control of a single mold 64. In the depicted, non-limiting embodiment, a counterweight system 68 can be utilized for each corner of the mold 64. Of course, the depiction of four counterweight systems is exemplary only, and such a depiction should not limit the scope of the claims appended herewith as the number and shape of molds will vary depending upon the number and desired shape of glass panes or laminate structures in a single pressing module 60.

As depicted in FIG. 7, an exemplary mold 64 can be suspended at four points, in this case at each corner of the mold 64. It should be noted that a 20 mm thick steel mold can itself deform up to 3 mm at room temperature, and such a deformation can be amplified at the pressing/bending temperatures contemplated herein as the respective Young's modulus may lose 40% of its value at 700° C. to 800° C., for example. Thus, embodiments of the present disclosure envision employing non-deformable molds as well as reinforced molds. Thus, in some embodiments, a four independent point suspension system can enable a fine tuning of the mold shape.

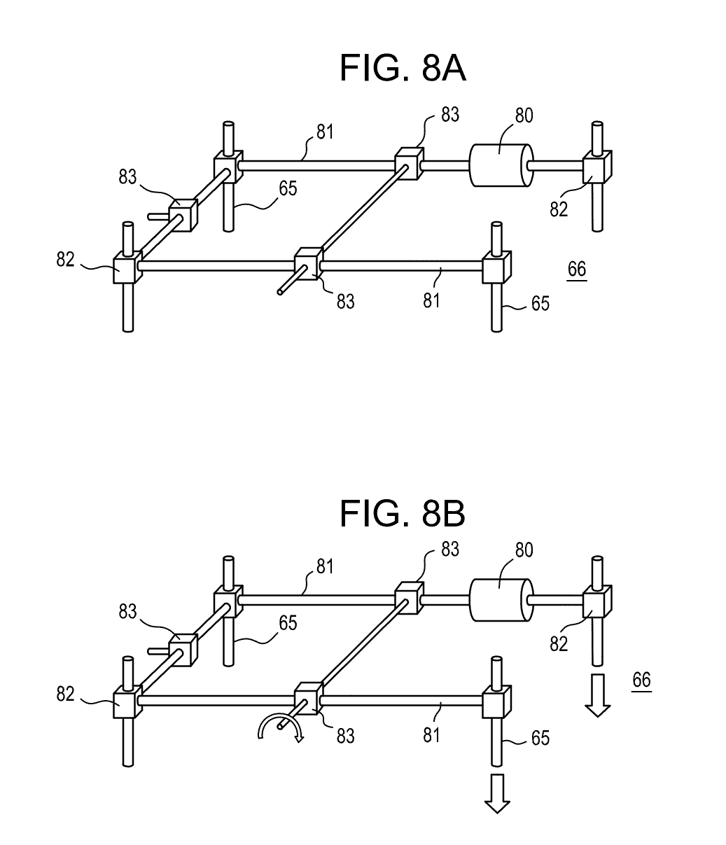

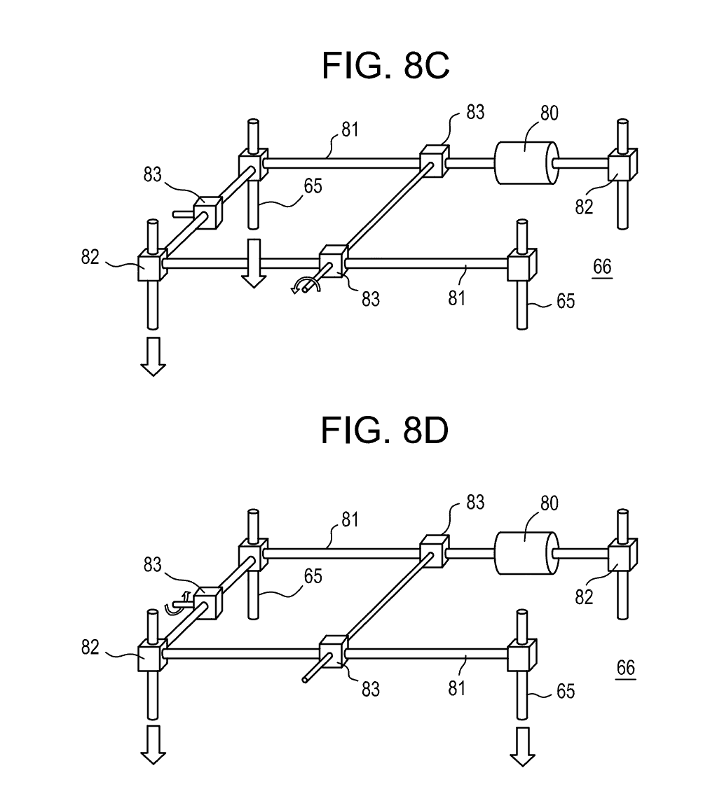

FIGS. 8A-8D are simplified depictions of the overhead mechanism of FIG. 6. With reference to FIGS. 8A-8D and continued reference to FIG. 7, an exemplary overhead mechanism 66 can be driven by one or more suitable motors 80 which rotatably actuates synchronized or asynchronized screws 82 via one or more linkages 81 and one or more differential gear boxes 83. During operation, each of these screws 82 (e.g., jack screws, lifting screws, or another suitable mechanism) engage the lifting cables, lifting screws, guide rods, chains 65 or other suitable mechanisms to lift an exemplary mold 64. The differential gear boxes 83 can provide lateral or transverse tilt adjustment of the mold 64 external the pressing module 60, that is, the tilt or cant of a mold 64 can be adjusted on a respective ring mechanism 62. Thus, by movement of one or more screws 82 while one or more other screws 82 are fixed, tilt control of a mold can be easily provided as illustrated in FIGS. 8B-8D. The importance of this tilt control can be observed in embodiments of the present disclosure that include a single mold but plural rings. Adjustment of the mold tilt can be employed to minimize press marks on the glass sheet or laminate structure and would conventionally require time consuming adjustments of each ring. Thus, an exemplary system can provide a tilt adjustment to the mold and can enable the mold to properly land on the glass sheet or laminate structure, so that the mold is parallel to the ring(s). This can reduce pressing marks as the impact force of the mold against the glass is spread over the ring perimeter. It should be noted that while one motor 80 has been illustrated, embodiments of the present disclosure should not be so limited as a motor can be paired with each screw 82 in an exemplary overhead mechanism 66. In such an embodiment, the addition of plural motors can reduce or eliminate the number of differential gear boxes 83 employed. It should also be noted that while exemplary pressing modules have been described as a part of a lehr, this should not limit the scope of the claims appended herewith as an exemplary pressing module can be separate and distinct (e.g., a standalone machine) from a lehr.

While the embodiments depicted herein are shown as a four point mold overhang system, the claims appended herewith should not be so limited as embodiments can include three point mold overhand systems, five point mold overhang systems, etc. as configurations according to the described embodiments can be utilized to better manage normal or complex geometries of an alloy steel or other non-rigid mold as discussed above. Thus, exemplary embodiments can allow operators to use hotter glass which would normally tend to degrade mold geometry as the mold needs to be heated at a higher temperature (e.g., chemically strengthened glass, Gorilla Glass, etc.).

Control of the stroke and force of exemplary embodiments can be performed utilizing programmable pressure, force or other profiles (e.g., temperature, etc.). That is, within each pressing module an exemplary control system can call up a predetermined profile and apply or reduce force as a function of controlling and monitoring counterweight force, stroke, motor speed, etc. By managing the counterweight values along the mold stroke and especially when the mold is self-registering in the lower ring, less vibrations are generated. Thus, when bending thin glass (which is less stable than thick glass) with embodiments described herein, less misalignment will be generated due to such control resulting in a more precise bend. Any number of or sets of values can be independently controlled to provide appropriate bending or pressing of one or more glass sheets or laminate structures. For example, a first set or number of glass sheets in a pressing module can be bent to a predetermined shape. Upon reaching certain setpoints (e.g., signals provided by force gauges, etc. to a PLC), a processor or controller in the control system (e.g., a PLC or the like) can move the mold in response to commands by an operator or from a software program embodied on a computer readable medium by adjusting the counterweight and/or turning on the motor/controlling the differential gear boxes. Through such programmable control of the counterweight and overhead system, a better reduction in press marks can be obtained as embodiments can be programmed to set or select values of force, stroke, position, etc. as a function of mold position, temperature, etc. For example, certain values can be set when a mold registers on a respective so as to minimize the ring and as a consequence the glass vibration. This can enable a better alignment of the glass or laminate versus the set of tool (mold+ring) which becomes more important when the glass sheets are thin and lightweight (e.g., Gorilla Glass). A second value can then be set when the mold is landing on the glass, e.g., a low value to minimize pressing marks. It then follows that an engineered curve can be set during the pressing phase to better manage the glass shape.

Embodiments of the subject matter and the functional operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer program products, i.e., one or more modules of computer program instructions encoded on a tangible program carrier for execution by, or to control the operation of, data processing apparatus. The tangible program carrier can be a computer readable medium. The computer readable medium can be a machine-readable storage device, a machine readable storage substrate, a memory device, or a combination of one or more of them.

The term “processor” or “controller” can encompass all apparatus, devices, and machines for processing data, including by way of example a programmable processor, a computer, or multiple processors or computers. The processor can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more data memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), to name just a few.

Computer readable media suitable for storing computer program instructions and data include all forms data memory including nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, input from the user can be received in any form, including acoustic, speech, or tactile input.

Embodiments of the subject matter described herein can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described herein, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

In some embodiments, a mechanism for bending glass is provided comprising a seating device and a mold configured to bend a substrate to a desired shape, the substrate adaptable to be provided on the seating device, wherein a position of the mold in relation to the seating device is controlled by a programmable counterweight system. In other embodiments, the programmable counterweight system can include a plurality of guide devices fixedly attached to the mold on a proximate end of each device and movably connected to screws at a distal portion of each guide device, an adjustable counterweight connected to each of the plurality of guide devices, and one or more motors configured to attach to the screws, wherein rotational movement of the one or more motors is translated to linear movement of one or more of the plurality of guide devices to effect linear travel of the mold. Exemplary guide devices can be, but are not limited to, guide rods, chains, cables lifting screws, and combinations thereof. In other embodiments, one or more differential gears can be used to effect lateral or transverse tilt to the mold when the one or more motors is actuated. In further embodiments, the one or more motors can further comprise a motor paired with each screw to effect lateral or transverse tilt to the mold when the paired motors are actuated singly or in combination. These motors can be rotably attached to linkages, the linkages being rotatably attached to respective screws. Suitable seating devices can be, but are not limited to, one or more ring mechanisms. Exemplary molds can be deformable at temperatures greater than 500° C. Exemplary substrates can be, but are not limited to, a glass sheet, a laminate structure, chemically strengthened glass, soda lime glass, tempered glass, non-chemically strengthened glass, and combinations thereof. Thickness of the substrate can be up to about 2.1 mm, up to about 1.5 mm or 1.6 mm, up to about 1.0 mm, up to about 0.7 mm, or in a range of from about 0.5 mm to about 1.6 mm, or from about 0.5 mm to about 0.7 mm or from about 0.3 mm to about 0.7 mm. In a further embodiment, the counterweight system can use pressure profiles, force profiles, temperature profiles or combinations thereof to apply or reduce force of the mold on the seating device as a function of adjustable counterweight, motor speed, or guide rod position. These profiles can be determined as a function of the size of the substrate, thickness of the substrate, number of substrates, number of molds, number of seating devices, and combinations thereof.

In other embodiments, a mechanism for bending thin glass is provided comprising a seating device and a mold configured to bend a substrate to a desired shape, the substrate adaptable to be provided on the seating device, wherein a position of the mold in relation to the seating device is controlled by a programmable counterweight system utilizing a pressure profile, force profile, temperature profile or combinations thereof to apply or reduce force of the mold on the seating device. In some embodiments, the programmable counterweight system can include a plurality of guide devices fixedly attached to the mold on a proximate end of each rod and movably connected to screws at a distal portion of each guide device, an adjustable counterweight connected to each of the plurality of guide devices, and one or more motors configured to attach to the screws, wherein rotational movement of the one or more motors is translated to linear movement of one or more of the plurality of guide devices to effect linear travel of the mold. In further embodiments, one or more differential gears can be used to effect lateral or transverse tilt to the mold when the one or more motors is actuated. In additional embodiments, the one or more motors can include a motor paired with each screw to effect lateral or transverse tilt to the mold when the paired motors are actuated singly or in combination. In other embodiments, the seating device can comprise one or more ring mechanisms. Exemplary substrates can be, but are not limited to, a glass sheet, a laminate structure, chemically strengthened glass, soda lime glass, tempered glass, non-chemically strengthened glass, and combinations thereof. Thickness of the substrate can be up to about 2.1 mm, up to about 1.5 mm or 1.6 mm, up to about 1.0 mm, up to about 0.7 mm, or in a range of from about 0.5 mm to about 1.6 mm, or from about 0.5 mm to about 0.7 mm or from about 0.3 mm to about 0.7 mm.

In further embodiments, a mechanism for bending thin glass is provided comprising a seating device, and a mold configured to bend a substrate to a desired shape, the substrate provided on the seating device, wherein a position of the mold in relation to the seating device is controlled by a programmable counterweight system utilizing pressure, force, temperature profiles or combinations thereof to apply or reduce force of the mold on the seating device. The programmable counterweight system comprises a plurality of guide devices fixedly attached to the mold on a proximate end of each rod and movably connected to screws at a distal portion of each device, an adjustable counterweight connected to each of the plurality of guide devices, and one or more motors configured to attach to the screws, wherein rotational movement of the one or more motors is translated to linear movement of one or more of the plurality of guide devices to effect linear travel of the mold and to effect lateral or transverse tilt to the mold. In additional embodiments, the one or more motors can include a motor paired with each screw to effect lateral or transverse tilt to the mold when the paired motors are actuated singly or in combination. In other embodiments, the seating device can comprise one or more ring mechanisms. Exemplary substrates can be, but are not limited to, a glass sheet, a laminate structure, chemically strengthened glass, soda lime glass, tempered glass, non-chemically strengthened glass, and combinations thereof. Thickness of the substrate can be up to about 2.1 mm, up to about 1.5 mm or 1.6 mm, up to about 1.0 mm, up to about 0.7 mm, or in a range of from about 0.5 mm to about 1.6 mm, or from about 0.5 mm to about 0.7 mm or from about 0.3 mm to about 0.7 mm.

Embodiments described herein can thus press bend thin glass at high temperature and provide precision bending of such glass or shaped glass. Some embodiments can be utilized on a machine or lehr with multiple rings and can press bend glass with a low pressing mark level. Exemplary embodiments can thus be particularly suited for thin glass forming as the contour tends to be hotter and have a tendency to be more sensitive to press marks. Exemplary embodiments can enable live adjustment of mold tilt which can be necessary to properly align the mold versus a respective ring. In embodiments having a single mold/single ring, such an adjustment can be accomplished on the ring; however, for multiple ring based machines, adjusting the mold with embodiments described herein can increase process efficiency, quality improvement and better yields, reduction in press marks, reduction in self-deformation of a stainless steel mold by limiting overhanging, and can assist running at higher temperatures as Young moduli of metals decrease with temperature meaning that mold geometry may drift with higher temperatures.

While this description may include many specifics, these should not be construed as limitations on the scope thereof, but rather as descriptions of features that may be specific to particular embodiments. Certain features that have been heretofore described in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and may even be initially claimed as such, one or more features from a claimed combination may in some cases be excised from the combination, and the claimed combination may be directed to a subcombination or variation of a subcombination.

Similarly, while operations are depicted in the drawings or figures in a particular order, this should not be understood as requiring that such operations be performed in the particular order shown or in sequential order, or that all illustrated operations be performed, to achieve desirable results. In certain circumstances, multitasking and parallel processing may be advantageous

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

It is also noted that recitations herein refer to a component of the present disclosure being “configured” or “adapted to” function in a particular way. In this respect, such a component is “configured” or “adapted to” embody a particular property, or function in a particular manner, where such recitations are structural recitations as opposed to recitations of intended use. More specifically, the references herein to the manner in which a component is “configured” or “adapted to” denotes an existing physical condition of the component and, as such, is to be taken as a definite recitation of the structural characteristics of the component.

As shown by the various configurations and embodiments illustrated in the figures, various tunable mold systems for glass press bending equipment have been described.

While preferred embodiments of the present disclosure have been described, it is to be understood that the embodiments described are illustrative only and that the scope of the invention is to be defined solely by the appended claims when accorded a full range of equivalence, many variations and modifications naturally occurring to those of skill in the art from a perusal hereof.

We claim:

1. A mechanism for bending glass comprising:
a seating device; and
a mold configured to bend a substrate to a desired shape, the substrate adaptable to be provided on the seating device,
wherein a position of the mold in relation to the seating device is controlled by a programmable counterweight system.

2. The mechanism of claim 1, wherein the programmable counterweight system comprises:
a plurality of guide devices fixedly attached to the mold on a proximate end of each device and movably connected to screws at a distal portion of each guide device;
an adjustable counterweight connected to each of the plurality of guide devices; and
one or more motors configured to attach to the screws, wherein rotational movement of the one or more motors is translated to linear movement of one or more of the plurality of guide devices to effect linear travel of the mold.

3. The mechanism of claim 2, wherein the guide devices are selected from the group consisting of guide rods, chains, cables lifting screws, and combinations thereof.

4. The mechanism of claim 2, further comprising one or more differential gears in communication with the one or more motors, the one or more differential gears configured to laterally or transversely tilt the mold when the one or more motors is actuated.

5. The mechanism of claim 2, wherein the one or more motors further comprises a motor paired with each screw to laterally or transversely tilt the mold when the paired motors are actuated singly or in combination.

6. The mechanism of claim 2, wherein the one or more motors are rotably attached to linkages, the linkages being rotatably attached to respective screws.

7. The mechanism of claim 1, wherein the seating device comprises one or more ring mechanisms.

8. The mechanism of claim 1, wherein the mold is deformable at temperatures greater than 500° C.

9. The mechanism of claim 1, wherein the substrate is selected from the group consisting of a glass sheet, a laminate structure, chemically strengthened glass, soda lime glass, tempered glass, non-chemically strengthened glass, and combinations thereof.

10. The mechanism of claim 1, wherein the substrate has a thickness of up to about 2.1 mm, up to about 1.5 mm or 1.6 mm, up to about 1.0 mm, up to about 0.7 mm, or in a range of from about 0.5 mm to about 1.6 mm, or from about 0.5 mm to about 0.7 mm or from about 0.3 mm to about 0.7 mm.

11. The mechanism of claim 2, wherein the counterweight system uses pressure profiles, force profiles, temperature profiles or combinations thereof to apply or reduce force of the mold on the seating device as a function of adjustable counterweight, motor speed, or guide rod position.

12. The mechanism of claim 11, wherein the profiles are determined as a function of a value selected from the group consisting of size of the substrate, thickness of the substrate, number of substrates, number of molds, number of seating devices, and combinations thereof.

13. A mechanism for bending thin glass comprising:
a seating device; and
a mold configured to bend a substrate to a desired shape, the substrate adaptable to be provided on the seating device,
wherein a position of the mold in relation to the seating device is controlled by a programmable counterweight system utilizing a pressure profile, force profile, temperature profile or combinations thereof to apply or reduce force of the mold on the seating device.

14. The mechanism of claim 13, wherein the programmable counterweight system comprises:
a plurality of guide devices fixedly attached to the mold on a proximate end of each rod and movably connected to screws at a distal portion of each guide device;
an adjustable counterweight connected to each of the plurality of guide devices; and
one or more motors configured to attach to the screws, wherein rotational movement of the one or more motors is translated to linear movement of one or more of the plurality of guide devices to effect linear travel of the mold.

15. The mechanism of claim 14, further comprising one or more differential gears in communication with the one or more motors, the one or more differential gears configured to laterally or transversely tilt the mold when the one or more motors is actuated.

16. The mechanism of claim 14, wherein the one or more motors further comprises a motor paired with each screw to laterally or transversely tilt the mold when the paired motors are actuated singly or in combination.

17. The mechanism of claim 13, wherein the seating device comprises one or more ring mechanisms.

18. The mechanism of claim 13, wherein the substrate is selected from the group consisting of a glass sheet, a laminate structure, chemically strengthened glass, soda lime glass, tempered glass, non-chemically strengthened glass, and combinations thereof.

19. The mechanism of claim 13, wherein the substrate has a thickness of up to about 2.1 mm, up to about 1.5 mm or 1.6 mm, up to about 1.0 mm, up to about 0.7 mm, or in a range of from about 0.5 mm to about 1.6 mm, or from about 0.5 mm to about 0.7 mm or from about 0.3 mm to about 0.7 mm.

20. A mechanism for bending thin glass comprising:
a seating device; and
a mold configured to bend a substrate to a desired shape, the substrate provided on the seating device,
wherein a position of the mold in relation to the seating device is controlled by a programmable counterweight system utilizing pressure, force, temperature profiles or combinations thereof to apply or reduce force of the mold on the seating device, and
wherein the programmable counterweight system comprises:
a plurality of guide devices fixedly attached to the mold on a proximate end of each rod and movably connected to screws at a distal portion of each device;
an adjustable counterweight connected to each of the plurality of guide devices; and
one or more motors configured to attach to the screws, wherein rotational movement of the one or more motors is translated to linear movement of one or more of the plurality of guide devices to effect linear travel of the mold and to effect lateral or transverse tilt to the mold.
